(19) United States
(12) Patent Application Publication
(10) Pub. No.: US 2021/0122302 A1
(43) Pub. Date: Apr. 29, 2021

(54) HALO LIGHTED BADGE

(71) Applicant: William McClelland, Waterford, MI (US)

(72) Inventor: William McClelland, Waterford, MI (US)

(21) Appl. No.: 17/077,724

(22) Filed: Oct. 22, 2020

Related U.S. Application Data
(60) Provisional application No. 62/925,816, filed on Oct. 25, 2019.

(51) Int. Cl. B60R 13/00; B60Q 1/26; B60Q 1/56; F21S 43/14

(52) U.S. Cl. CPC B60R 13/005; F21S 43/14; B60Q 1/56; B60Q 1/2696

(57) ABSTRACT

An illuminated automotive badge is described. The illuminated automotive badge comprises an emblem, a light guide, and an LED assembly. The LED assembly may comprise a plurality of LEDs attached to a mount. A light guide may be disposed over the LED assembly. The light guide has optical properties that spread the light emitted from the LEDs to the edges of the emblem. As such, the light emitted by the LEDs provides an indirect light source for illuminating the emblem. The illuminated automotive badge may further comprise a housing configured to block stray light.

### FIELD OF INVENTION

This invention relates to an automotive badge, and more particularly to an illuminated automotive badge.

### BACKGROUND

In general, automotive manufacturers mount badges on their vehicles to display a vehicle manufacturer's logo, name, trademark, or other graphic. It is desirable to have a prominent badge that is ascetically appealing. However, badges must also pass validation requirements and be cost effective. Therefore, there is a need for an attractive badge that stands out, but that also passes validation requirements and is cost effective.

### SUMMARY

An illuminated automotive badge is described herein. The illuminated automotive badge comprises an emblem, a light guide, and a light-emitting diode (LED) assembly. The LED assembly may comprise a plurality of LEDs attached to a mount. A light guide may be disposed over the LED assembly. The light guide has optical properties that spread the light emitted from the LEDs to the edges of the emblem. As such, the light emitted by the LEDs provides an indirect light source for illuminating the emblem. The illuminated automotive badge may further comprise a housing that is wrapped around the light guide and configured to block stray light.

### BRIEF DESCRIPTION OF THE DRAWINGS

FIG. 1 is a front view of an illuminated badge, according to an embodiment;

FIG. 2 is an exploded side view of the illuminated badge of FIG. 1, according to an embodiment;

FIG. 3 is a side view of the illuminated badge of FIG. 1, according to an embodiment; and

FIG. 4 is a front view of an illuminated badge, according to an embodiment.

### DETAILED DESCRIPTION OF THE PREFERRED EMBODIMENTS

Examples of illuminated badges will be described more fully herein with reference to the accompanying drawings. These examples are not mutually exclusive, and features found in one example can be combined with features found in one or more other examples to achieve additional implementations. Accordingly, it will be understood that the examples shown in the accompanying drawings are provided for illustrative purposes only and they are not intended to limit the disclosure in any way. Like numbers refer to like elements throughout.

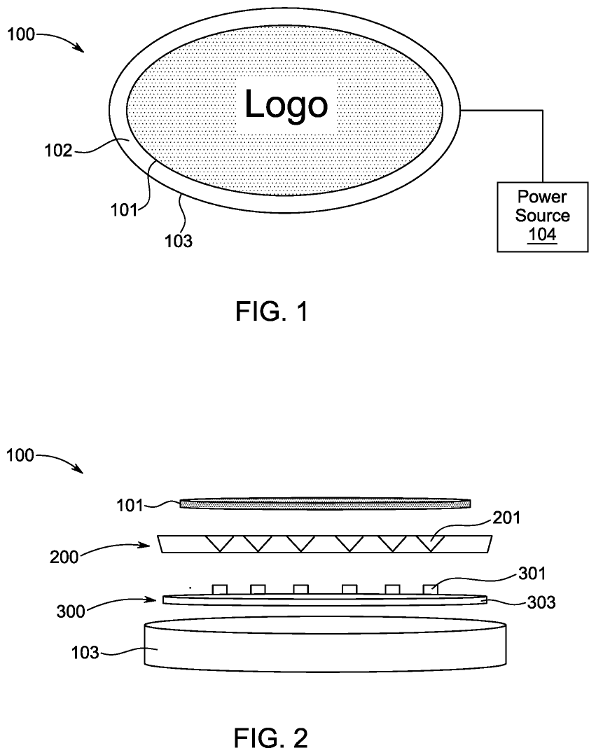

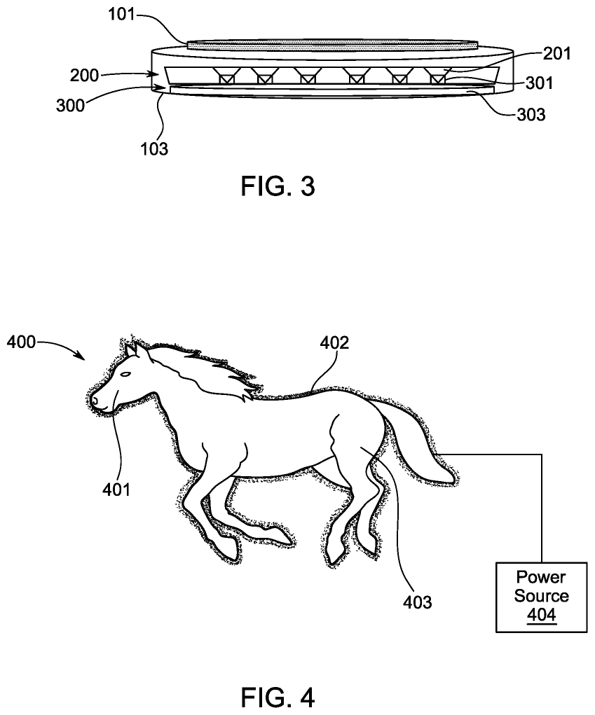

With reference to FIGS. 1-3, the illuminated badge 100 of the present disclosure comprises an emblem 101, a light guide 200, and a light-emitting diode (LED) assembly 300. The illuminated badge may further comprise a housing 103.

The illuminated badge 100 as described herein may be configured to attach to a vehicle. For example, the illuminated badge 100 may comprise tabs (not shown) configured to couple to a vehicle. However, as will be appreciated by one having ordinary skill in the art, a variety of mechanisms may be used to attach the illuminated badge 100 to a vehicle.

The emblem 101 may comprise various shapes including, but not limited to, rectangular, oval, circular or triangular. For example, in FIGS. 1-3, the emblem 101 is oval shaped. In some embodiments, the emblem comprises a unique shape of the logo of the vehicle manufacturer. For example, in FIG. 4, the emblem 401 is in the shape of a horse, which is the logo of the vehicle manufacturer. In embodiments, the emblem 101 may be comprised of a metallic, chrome, and/or polymeric material.

The LED assembly 300 may comprise a plurality of LEDs 301 attached to a mount 303. In embodiments, the plurality of LEDs 301 may be red, green, and blue (RGB) LEDs. As such, the LEDs may provide multiple color options.

The number and placement of the plurality of LEDs 301 may be different for different emblems 101. For example, a larger emblem 101 may require more LEDs 301. In addition, the placement of the LEDs 301 may depend on the shape of the emblem 101.

In embodiments, the LED assembly 300 receives commands from a vehicle's interior ambient system. In further embodiments, the LED assembly 300 further comprises a circuit (not shown) configured to allow the LED assembly 300 to emit multi-color options only when the vehicle is in park. Additionally, or alternatively, the circuit may be further configured to allow the LED assembly 300 to emit legal colors and intensities when the vehicle is in drive.

The illuminated badge 100 of the present disclosure may be useful in ride shares and autonomous vehicles. For example, in a ride share, the illuminated badge 100 may emit the color red when the vehicle is in park and the driver is waiting for a customer and then may emit the color green once the customer has been picked up and the driver is driving to the customer's destination. As will be appreciated by one having ordinary skill in the art, the badge 100 may illuminate a variety of different colors.

The light guide 200 overlays the plurality of LEDs 301. As such, the plurality of LEDs 301 emit light rays into the light guide 200. The light guide 200 comprises optics 201 configured to spread the light rays emitted from the plurality of LEDs 301 to the edges of the emblem 101. As such, the light rays provide an indirect light source through the light guide 200. Light rays emitted from the plurality of light emitting devices 301 may therefore create a halo effect around the emblem 101.

The size and shape of the light guide 200 may depend on the size and shape of the emblem. For example, in embodiments, the light guide 200 is substantially the same size and shape as the emblem 101. Similarly, the optics 201 of the light guide 200 may depend on the size and shape of the emblem. For example, the light guide 200 for the emblem 101 of FIG. 1 may comprise different optics than a light guide designed for the emblem 400 of FIG. 4.

In embodiments, the emblem 101 is configured to couple to the light guide 200.

The illuminated badge 100 may be connected to a power source 104. The power source 104 may supply power to the plurality of LEDs 301. In embodiments, the power source 104 may comprise a vehicle's running lamp circuit.

In embodiments, the illuminated badge 100 may further comprise a housing 103. The housing 103 may be coupled to the mount 303 of the LED assembly 300. The housing 103 may be configured to wrap around the light guide 200 and may be separated from the emblem 101 by a gap 102. The size and shape of the housing 103 may depend on the size and shape of the emblem 100. For example, in embodiments, the housing 103 has the same shape as the emblem 100. In further embodiments, the housing 103 is only marginally larger than the emblem 100. As such, the housing 103 may prevent stray rays emitted from the plurality of LEDs 301 from illuminating the areas to the sides of the emblem 101.

In embodiments, the housing 103 further comprises a mechanism to couple to a vehicle. For example, the housing 103 of the illuminated badge may comprise tabs (not shown) configured to mate with a grille of a vehicle.

FIG. 4 is a front view of illuminated badge 400. Illuminated badge 400 comprises an emblem 401 that is in the shape of a logo of a vehicle manufacturer. The illuminated badge 400 comprises a housing 403 separated from the emblem 401 by a gap 402. The illuminated badge 400 comprises an LED assembly and light guide as described above. The number and placement of the plurality of LEDs, as well as the size, shape, and optics of the light guide are optimized for emblem 401 to create the desired halo effect around the emblem 401, as also discussed above.

Although features and elements are described above in particular combinations, one of ordinary skill in the art will appreciate that each feature or element can be used alone or in any combination with the other features and elements.

What is claimed is:

1. An illuminated light badge comprising:
an emblem;
a light guide; and
a light emitting diode (LED) assembly comprising a plurality of LEDs attached to a mount,
wherein the light guide comprises optics configured spread light rays emitted from the plurality of LEDs to an outer edge of the emblem.

2. The illuminated light badge of claim 1, wherein the light guide creates a halo effect around the emblem.

3. The illuminated light badge of claim 1, wherein a number and placement of the plurality of LEDs of the LED assembly is optimized for a size and shape of the emblem.

4. The illuminated light badge of claim 3, wherein the size, shape, and optics of the light guide is optimized for the size and shape of the emblem.

5. The illuminated light badge of claim 1, further comprising a housing that surrounds the light guide and is configured to block stray light rays emitted from the plurality of LEDs.

6. The illuminated light badge of claim 5, wherein the housing comprises tabs configured to couple to a vehicle.

7. The illuminated light badge of claim 5, wherein the housing is substantially the same shape as the emblem.

8. The illuminated light badge of claim 1, wherein the illuminated badge is coupled to a vehicle and the LED assembly is electrically connected to and receives commands from the vehicle's interior ambient system.

9. The illuminated light badge of claim 1, wherein the plurality of LEDs comprise RGB LEDs configured to emit light of various colors.

10. The illuminated light badge of claim 9, wherein the LED assembly further comprises a circuit configured to permit the LED assembly to emit light of various colors when the vehicle is in park.

11. The illuminated badge of claim 10, wherein the circuit is further configured to prevent the LED assembly from emitting light of certain colors and intensities when the vehicle is in drive.

12. The illuminated light badge of claim 1, wherein the shape of the emblem is a logo of a vehicle manufacturer.

13. The illuminated badge of claim 1, wherein the emblem is comprised of solid chrome.

14. The illuminated badge of claim 1, wherein the LED assembly is configured to connect to a power source.

15. The illuminated badge of claim 14, wherein the power source is a vehicle's running lamp circuit.

16. A vehicle system comprising:
an interior ambient system; and
a badge assembly comprising:
an emblem;
a light guide; and
a light emitting diode (LED) assembly comprising a plurality of LEDs attached to a mount,
wherein the LED assembly is electrically connected to and receives commands from the vehicle's interior ambient system, and
the light guide comprises optics configured to spread light rays emitted from the plurality of LEDs an outer edge of the emblem.

17. The vehicle system of claim 16, further comprising a power source connected to the LED assembly.

18. The vehicle system of claim 17, wherein the power source is a running lamp circuit.
